(19) United States
(12) Patent Application Publication
(10) Pub. No.: US 2003/0227522 A1
(43) Pub. Date: Dec. 11, 2003

(54) Replaceable ink jet print head cartridge assembly with installation feature

(75) Inventors: Yichuan Pan, San Diego, CA (US); Mark M. Broschart, San Diego, CA (US); David A. Neese, Escondido, CA (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/163,847

(22) Filed: Jun. 6, 2002

(51) Int. Cl. B41J 2/175

(52) U.S. Cl. 347/85

(57) ABSTRACT

An ink jet cartridge assembly includes a pen body housing having an ink container, a jet plate coupled to the pen body for ejecting droplets of ink, and an ink inlet port through one wall of the housing. A connection tube is attached to the ink inlet. The connection tube has a septum which is remote from the inlet port, whereby the septum is adapted for connection to an ink supply.

### FIELD OF THE INVENTION

The present invention relates generally to ink jet printers, and more particularly to an inkjet print head cartridge assembly adapted for installation with reduced leakage.

### BACKGROUND OF THE INVENTION

Ink jet type printers typically employ a pen body that is moved in a transverse fashion across a print media. Contemporary disposable ink pen bodies typically include a self-contained ink container, a print head supporting a plurality of ink jet nozzles in combination with the ink reservoir, and a plurality of external electrical contacts for connecting the ink jet nozzles to driver circuitry.

U.S. Pat. No. 5,686,947, which issued to Murray et al. on Nov. 11, 1997, discloses an inkjet printer which provides a continuous volume of ink to a pen body from a large, refillable ink reservoir permanently mounted within the ink jet printer. Flexible tubing, also permanently mounted within the ink jet printer, connects the reservoir to the pen body.

Even with the possibility of replenishment of the ink container within a disposable ink jet pen body, there eventually comes a time when the pen body must be replaced. Therefore, there is a substantial need to supply the market with replacement pen bodies. Leakage of ink from pen bodies during installation has been a problem in the industry. Consequently, replacement pen bodies have been shipped with “breathing” caps so that the pressure inside the pen bodies is equal to atmospheric pressure during shipping to deal with the elevation and temperature changes. Installation of pen bodies with breathing caps can be messy, as ink can leak from the ink inlet or from the nozzles during the installation process.

### SUMMARY OF THE INVENTION

According to a feature of the present invention, ink pen bodies are provided for shipping with a connection tube that seals off the ink inlet to form a cartridge assembly. The pre-installed connection tube makes installation of cartridge assemblies according to the present invention into a printer a simple task.

According to another feature of the present invention, an inkjet cartridge assembly includes a pen body housing having an ink container, a jet plate coupled to the pen body for ejecting droplets of ink, and an ink inlet port through one wall of the housing. A connection tube is attached to the ink inlet. The connection tube has a septum which is remote from the inlet port, whereby the septum is adapted for connection to an ink supply.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1A is a front view of an ink jet pen body according to the present invention;

FIG. 1B is a rear view of the inkjet pen body of FIG. 1A;

FIG. 2 is a perspective view of the ink jet pen body and an attached connection tube to form a cartridge assembly according to the present invention;

FIG. 3A is a perspective view of one embodiment of the connection tube shown of FIG. 2;

FIG. 3B is a perspective view of another embodiment of the connection tube shown of FIG. 2;

FIG. 3C is a perspective view of yet another embodiment of the connection tube shown of FIG. 2 and having a quick disconnect valve fitting;

FIG. 4 is a cross-sectional view of the ink jet cartridge assembly taken along line 240-240 of FIG. 2;

FIG. 5 is a view of an inkjet printer carriage and a disposable ink jet cartridge assembly according to FIGS. 1-4 shown connected to an ink line in a printer; and

FIG. 6 is a perspective view of an ink jet printer carriage with disposable ink jet cartridge assemblies according to FIGS. 1-4 shown being supplied ink by remote large volume reservoirs.

### DETAILED DESCRIPTION OF THE INVENTION

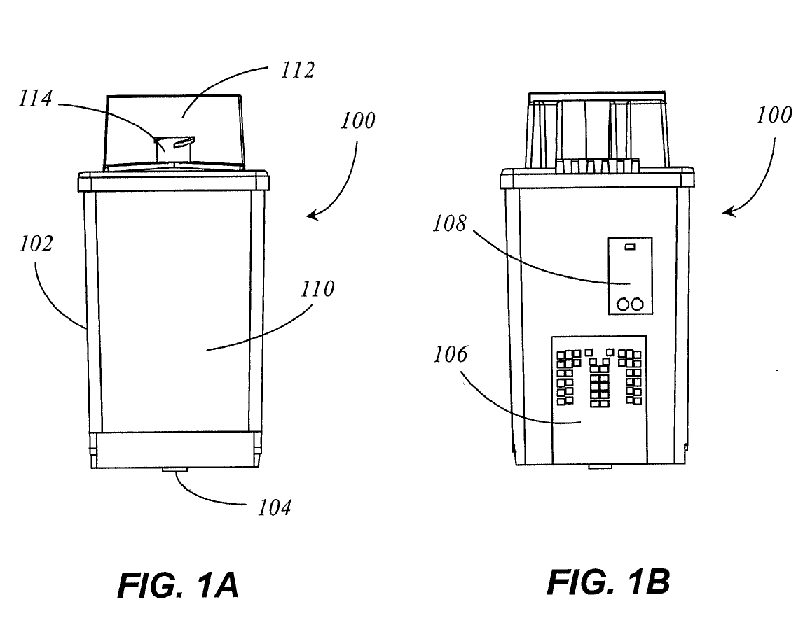

A preferred pen body for use with the present invention is similar to those pen bodies well known in the art such as the 208-jet™ cartridge, Part No. 12A1970, from Lexmark International Inc., in Lexington, Ky. However, modifications to this basic assembly have been made to provide an opening for supplying ink from an external reservoir. Referring to FIGS. 1A and 1B, a pen body 100 according to the present invention includes a housing 102 as in the Lexmark Part. No. 12A1970, a jet plate 104, an electrical connector assembly 106, a memory chip assembly 108, an ink container 110, and atop lid 112. The capacity of ink container 110 is preferably approximately 65 ml volume for commercially available ink jet printers, but other size pen bodies can be used with the present invention.

Jet plate 104 includes a plurality of ink jet nozzles that may be conventional in design. The jet plate is mounted to a bottom surface of pen body housing 102 such that ink ejected from the jet plate deposits onto paper or other print media which is positioned on a platen below pen body 100.

Electrical connector assembly 106 is positioned on pen body housing 102 to align with a mating electrical connector assembly (not shown) on a pen body holder as is conventional for ink jet printers. Connector assembly 106 transfers electrical control signals from the main control electronics in the printer housing to jet plate 104 for controlling the printing operation in a manner well known in the art.

Memory chip assembly 108 is attached to the pen body housing 102 using a conventional method, such as adhesive and is positioned to align with the mating electrical connector assembly (not shown) on a pen body holder as is conventional for inkjet printers. Memory chip assembly 108 has a memory chip to hold data for the pen body and the ink jet printer system, such as ink type and color and the amount of ink used for the pen body. The function of the memory chip assembly 108 is disclosed in U.S. Pat. No. 5,610,635, which issued to Murray et al. on May 11, 1997.

Top lid 112, preferably plastic, is attached, such as by ultrasonic welding, to housing 102. The top lid has an integral opening and a female portion 114 of a quick disconnect fitting, preferably designed to standard female Luer Lock dimensions.

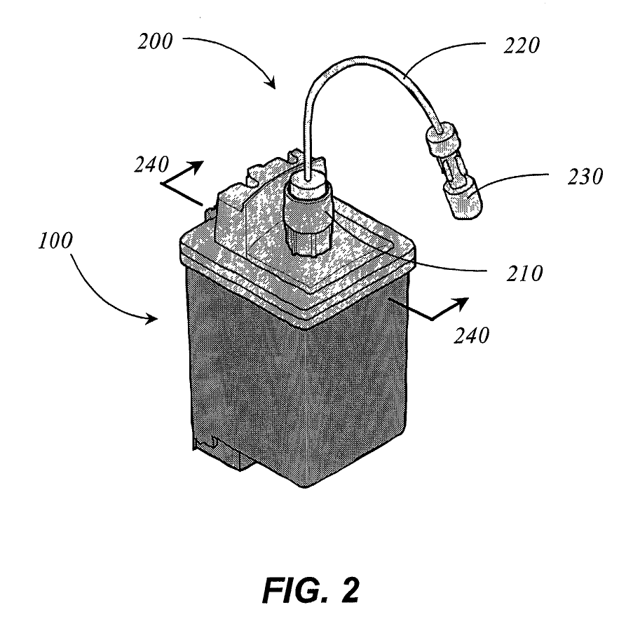

FIG. 2 is a perspective view of the ink jet pen body 100 of FIGS. 1A and 1B and a connection tube 200 attached to pen body 100 to form a cartridge assembly. Connection tube 200 consists of a quick disconnect fitting 210, a flexible tubing 220 and a septum assembly 230. The connections from flexible tubing 220 both to quick disconnect fitting 210 and to septum assembly 230 are established by barb fittings. The flexible tubing is preferably made of polyurethane, but can be made of other proper materials. Quick disconnect fitting 210 mates with female portion 114 on top lid 112 of cartridge assembly 100. Preferably, male portion 210 of the quick disconnect fitting is a conventional Luer Lock fitting. Female portion 114, which is integral on the pen body and male portion of quick disconnect fitting 210 form a hermetic seal there between when they are connected.

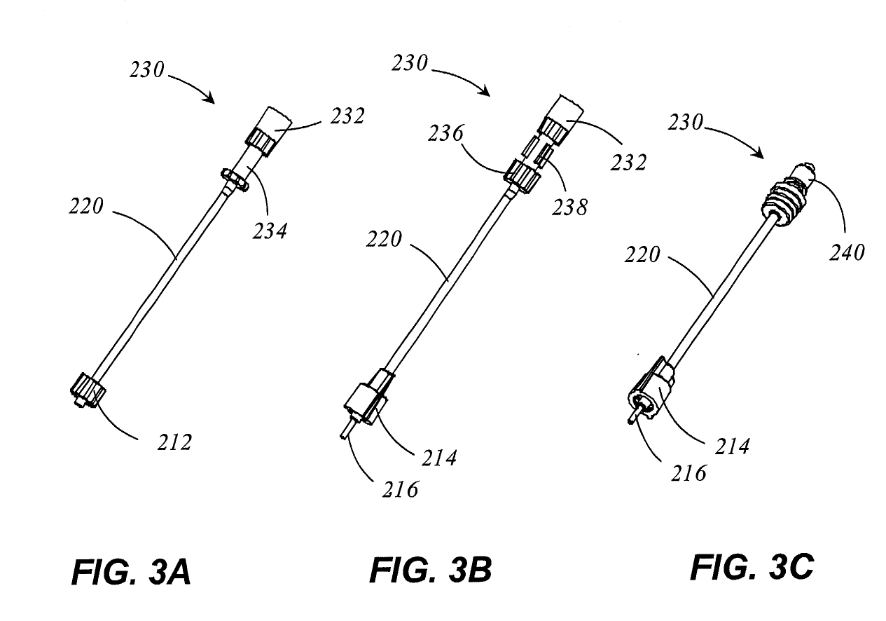

Many embodiments of connection tube 200 will occur to a person ordinarily skilled in the art. FIGS. 3A-3C provide three examples thereof. In FIG. 3A, quick disconnect fitting 212 is a commercially available part, such as Part No. MTLL210-6 from Value Plastics, Inc. in Fort Collins, Colo. The quick disconnect fitting 214 in FIGS. 3B and 3C has a tube 216 connected to the bottom tip of male portion. Tube 216 is bonded to male portion of quick disconnect fitting 214 by conventional bonding methods known to those of skill in the art such as, for example, by an adhesive bond. The tube 216 may be formed of stainless steel, polyurethane, or other suitable material.

In FIG. 3A, the septum assembly has two parts, a septum part 232 and an extension part 234 to connect the septum to tubing 220. The septum is preferably a commercially available part, such as Part No. 84039 from Qosina Company in Edgewood, N.Y. Extension part 234 in FIG. 3A may be replaced by the commercially available parts, such as those shown in FIG. 3B as a barb Luer fitting 236 and an extension tube 238. FIG. 3C shows an alternative of the septum. A quick disconnect valve fitting 240 is used to achieve the equivalent function of septum 232 to connect pen body 100 to the printer ink line.

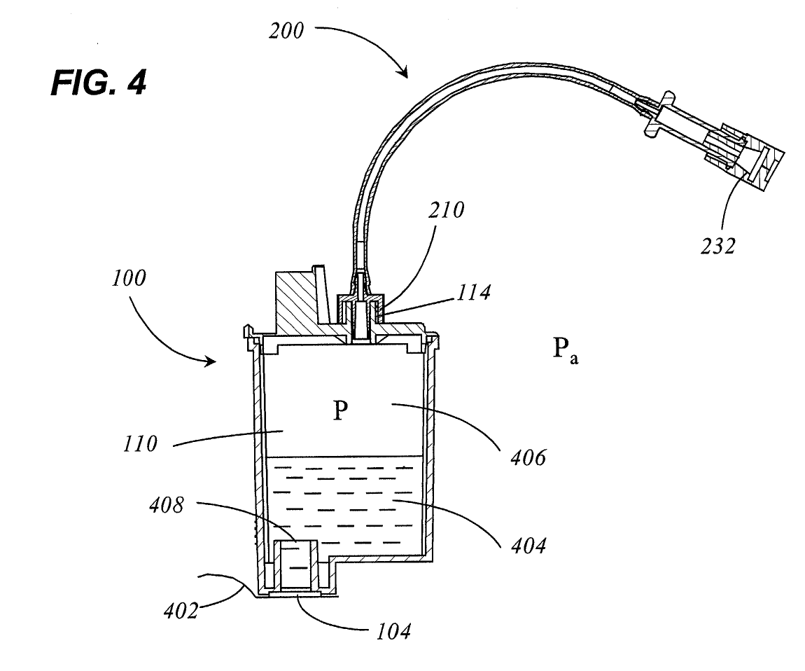

FIG. 4 is a cross-sectional view of pen body 100 and connection tube 200 attached, taking along line 240-240 of FIG. 2. Ink container 110 of pen body 100 is filled with a proper amount of ink 404. An adequate volume of air 406 remains in ink container 110 after the factory ink filling process. The volume of air serves as a pressure buffer to absorb pressure surges during printing. Adequate air volume for the purpose of pressure buffering can vary greatly as a percentage of the volume of ink container 110, and is determined by the requirement to the volume of ink 404. The volume of ink 404 needs to be enough to cover a filter 408. During printing, pen body 100 moves back and forth, causing ink 404 to slosh in ink container 110. Therefore, increasing the volume of ink 404 helps to cover filter 408 during printing. When ink container 110 has a volume of approximately 65 ml, it is preferred that the volume of ink 404 be more than 25 ml. Pen body 100 is hermetically sealed by male-to-female quick disconnect fittings 114 and 210 on top and by nozzle plate tape 402 at the bottom. Nozzle plate tape 402 is a commercially available tape relying either on a thin layer of tape adhesive or on electrical static to stick to the nozzle plate. If a layer of adhesive is provided, the adhesive layer on the tape needs to be very thin so as to not form a blockage after tape 402 is removed when pen body 100 is installed into a printer.

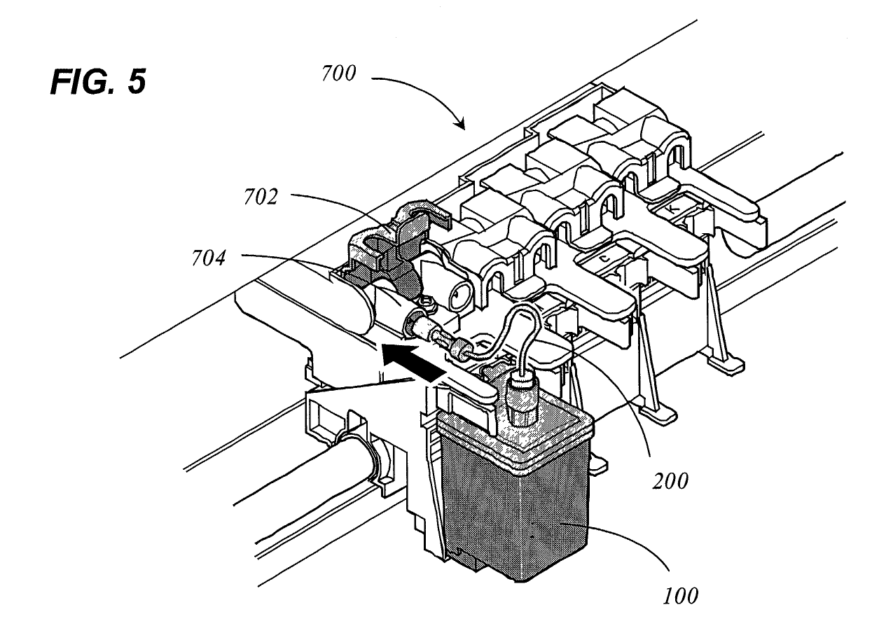

FIG. 5 is a perspective view of an ink jet print head cartridge assembly including pen body 100 with connection tube 200 installed into a carriage block 700 of a ink jet printer (not shown). An ink line valve 702 is open to expose a septum receiver 704 to connect connection tube 200. A needle inside septum receiver 704 pierces through septum 232 of the connection tube 200. Pull fluid communication between ink container 110 of pen body 100 and an ink line (not shown) is established when ink line valve 702 is closed. The internal pressure P in ink container 110 acts to draw ink from the ink line on the printer until internal pressure P equalizes with pressure in the ink reservoir on the printer. After the pressure equalization process, a customer can peal off nozzle tape 402 of nozzle plate 104 and start printing.

The quick disconnect between septum receiver 704 and septum 232 is preferred to be totally clean hands and easy to operate. The quick disconnect function advantageously enables the easy removal of the ink jet cartridge assembly from carriage block 700. Thus, when the print quality of jet plate 104 begins to degrade, an inkjet cartridge assembly can be easily removed and replaced with a new cartridge assembly having a new jet plate. The quick connect-disconnect can be achieved as known to one in the art with male-to-female connection when a male quick disconnect valve shown in FIG. 3C is used.

The volume of ink drawn from the printer ink line to cartridge ink container 110 depends on elevation of the customer. With initial internal pressure P₀ of 20.7 inch Hg, the relationship between the ink volume drawn to ink container 110 and customer's elevation can be established following the ideal gas law, as known to one skilled in the art, and is shown in the following table, assuming that the ink line in the printer is full of ink just prior to the installation process.

| Elevation (ft) | Ink Volume (ml) |
|---|---|
| at Customer | Drawn to Container |
| 0 | 12.5 |
| 1,000 | 11.5 |
| 2,000 | 10.4 |
| 3,000 | 9.3 |
| 4,000 | 8.1 |
| 5,000 | 6.9 |
| 6,000 | 5.7 |
| 7,000 | 4.4 |
| 8,000 | 3.0 |
| 9,000 | 1.5 |
| 10,000 | 0 |

The above table assumes that the ink line is full of ink just before the cartridge assembly installation process. If the ink line is not full, the amount of ink drawn to ink container 110 is less than the volume shown in the table. The volume of ink drawn into container 110 adds to the initial ink volume 404 in container 110. This ensures that cartridge filter 408 is fully covered during printing operation.

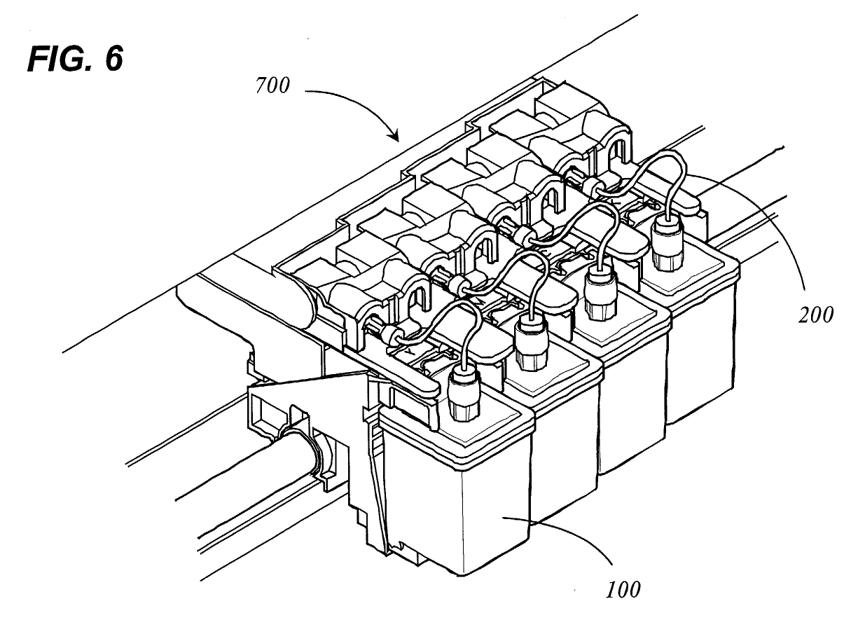

FIG. 6 is a perspective of ink jet printer carriage block 700 loaded with a plurality of print head cartridge assemblies according to the present invention. Additional details of printer carriage block 700, and of an inkjet printer in which it may be used, can be found in afore-mentioned U.S. Pat. No. 5,686,947.

What is claimed is:

1. An inkjet cartridge assembly comprising:
a pen body housing having an ink container;
a jet plate coupled to said pen body for ejecting droplets of ink;
an ink inlet port through one wall of the housing;
a connection tube attached to the ink inlet port, said connection tube having a septum remote from the inlet port, whereby the septum is adapted for connection to an ink supply.

2. An ink jet cartridge assembly as set forth in claim 1, wherein said one wall of the housing is ultrasonically welded to other housing walls.

3. An ink jet cartridge assembly as set forth in claim 1, wherein the jet plate is on a wall of the housing other than said one wall.

4. An ink jet cartridge assembly as set forth in claim 3, wherein the one wall and the other wall are apart and define substantially parallel planes.

5. An ink jet cartridge assembly as set forth in claim 1, wherein the connection tube is attached to the ink inlet port by a quick disconnect fitting.

6. An ink jet cartridge assembly as set forth in claim 5, wherein the quick disconnect fitting is a Luer Lock fitting.

7. An ink jet cartridge assembly as set forth in claim 5, wherein the connection tube is attached to the quick disconnect fitting by a barbed connection.

8. An inkjet cartridge assembly as set forth in claim 1, wherein the connection tube is attached to the septum by a barbed connection.

9. A connection tube adapted to removably interconnect a pen body and an ink supply, said connection tube comprising:
an elongated tube;
a connector attached at one end of the tube and being adapted to be releasably attached to an ink inlet port of said pen body; and
a septum attached at another end of the tube and being adapted to b releasably attached to the ink supply.

10. A connection tube as set forth in claim 8, wherein the connection tube is polyurethane.

11. A connection tube as set forth in claim 8, wherein the connector is a quick disconnect fitting.

12. A connection tube as set forth in claim 11, wherein the quick disconnect fitting is a Luer Lock fitting.

13. A connection tube as set forth in claim 11, wherein the connection tube is attached to the quick disconnect fitting by a barbed connection.

14. A connection tube as set forth in claim 8, wherein the connection tube is attached to the septum by a barbed connection.

15. A process for forming an ink jet cartridge assembly comprising:
providing a pen body housing having an ink container having a jet plate coupled thereto;
providing an ink inlet port through one wall of the pen body housing;
connecting a septum to one end of an elongated tube;
attaching the other end of the elongated tube to the ink inlet port, whereby the septum is adapted for connection to an ink supply.

16. A process as set forth in claim 15 further comprising the step of ultrasonically welding the one wall to the pen body housing.

17. A process as set forth in claim 15, wherein the one wall is remote from the jet plate.

18. A process as set forth in claim 15, wherein the elongated tube is attached to the ink inlet port by a quick disconnect fitting.

19. A process as set forth in claim 18, wherein the quick disconnect fitting is a Luer Lock fitting.

20. A process as set forth in claim 18, wherein the elongated tube is attached to the quick disconnect fitting by a barbed connection.

21. A process as set forth in claim 15, wherein the elongated tube is attached to the septum by a barbed connection.
